(19) United States
(12) Patent Application Publication
(10) Pub. No.: US 2012/0033413 A1
(43) Pub. Date: Feb. 9, 2012

(54) SOLAR LAMP

(76) Inventor: Zi-Hui LIU, Guangzhou City (CN)

(21) Appl. No.: 12/852,854

(22) Filed: Aug. 9, 2010

(51) Int. Cl. F21L 4/08; F21L 4/02

(52) U.S. Cl. 362/183

(57) ABSTRACT

The present invention discloses a solar lamp which includes a bottom seat, a housing, a solar cell, a control circuit board, rechargeable batteries and LEDs. The solar cell is installed at a top of the housing, the control circuit board, the rechargeable batteries and the LEDs are installed inside the housing, the top of the housing is provided with a top ornament and a lower side of the housing is supported by the bottom seat. The present invention enables a solar cell to have a larger power and the top ornament can compensate for incompleteness of the shape.

### BACKGROUND OF THE INVENTION

a) Field of the Invention

The present invention relates to a lighting lamp, and more particularly to a lamp which uses a solar cell as the energy source.

b) Description of the Prior Art

For an existing solar lamp, the solar cell should be installed at a top part where solar energy can be received and there are two ways of installing the solar cell. In one way, a solar cell is separated into plural small pieces which are emplaced at a smoother place on a top of the lamp. This method keeps integrity of a shape of the lamp but reduces an active area of the solar cell to decrease energy obtained by the light source. A second way is to design an entire top part of the lamp as a flat place for installing a large piece of solar cell. This method can increase the active area of the solar cell but will damage an overall effect of the lamp to affect beautifulness.

### SUMMARY OF THE INVENTION

The primary object of the present invention is to provide a solar lamp which keeps integrity of the shape of the lamp without reducing the active area of the solar cell.

To implement the aforementioned object, a technical means of the present invention is to provide a solar lamp which includes a bottom seat, a housing, a solar cell, a control circuit board, rechargeable batteries and LEDs (Light Emitting Diodes), wherein the solar cell is installed at a top of the housing, the control circuit board, the rechargeable batteries and the LEDs are installed inside the housing, an upper side of the housing is provided with a top ornament, whereas a lower side of the housing is supported by the bottom seat.

The said solar cell is fixed at the top end of the housing with marine glue and the said control circuit board, rechargeable batteries and LEDs are fixed on a cover board of battery box, with the cover board of battery box being connected to an interior of the housing through screws.

The said top ornament constructs a complete shape with the housing and the bottom seat, is assembled by parts of simple geometric shapes and is provided with a structure allowing a lot of light to leak out.

Comparing with the prior art, the present invention enables a solar cell to have a larger power and the top ornament can compensate for incompleteness of the shape.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of the present invention.

FIG. 2 shows a schematic view of assembly of the present invention (not including the bottom seat).

### DETAILED DESCRIPTION OF THE PREFERRED EMBODIMENTS

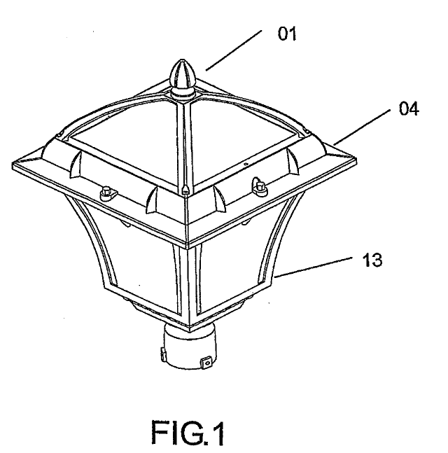

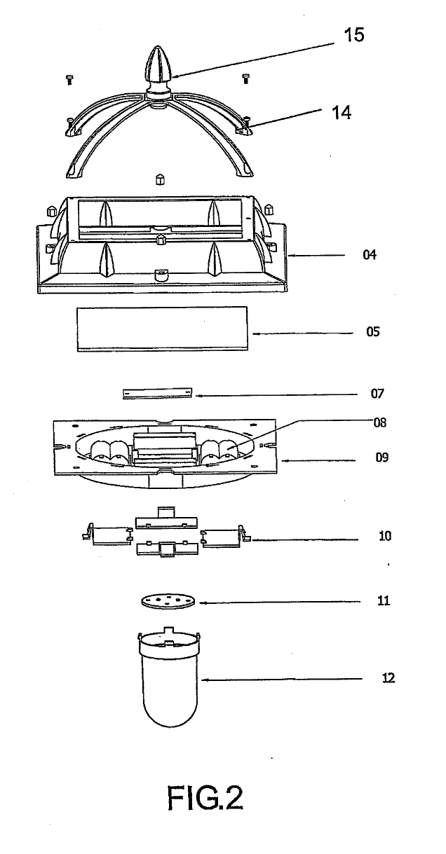

Referring to FIG. 1 and FIG. 2, a solar lamp of the present invention comprises a top ornament 1, a housing 4, a solar cell 5, a control circuit board 7, rechargeable batteries 8, a cover board of battery box 9, a battery box lid 10, an LED-aluminum substrate assembly 11, a light diffusion barrel 12 and a bottom seat 13. The solar cell 5 is fixed at a top of the housing 4, whereas the control circuit board 7, the rechargeable batteries 8 and the LED-aluminum substrate assembly 11 are fixed on the cover board of battery box 9. The cover board of battery box 9 that has been installed with the aforementioned components is installed inside the housing 4 and then the light diffusion barrel 12 is fixed below the cover board of battery box 9. Next, the solar cell 5, the control circuit board 7, the rechargeable batteries 8 and the LED-aluminum substrate assembly 11 are connected together by lead wires. Finally, the top ornament 1 is connected at the top of the housing 4.

The top ornament 1 is a part like a crown and includes four arc-shaped stripes 14 diagonally facing to each other and supporting a central dome 15 in a shape of diamond. The top ornament 1 is provided with a good light leakance that light can irradiate on the solar cell 5 on the top of the housing 4 from gaps among the four arc-shaped stripes, which has a very small influence to the reception effect of the solar cell 5. Although this specially designed top ornament can affect the efficiency of the solar cell, the influence is controlled to be within an overall acceptability and the top ornament can compensate for the incompleteness of the shape of an existing lamp.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A solar lamp comprising a bottom seat, a housing, a solar cell, a control circuit board, rechargeable batteries and LEDs (Light Emitting Diodes), wherein the solar cell is installed at a top of the housing, the control circuit board, the rechargeable batteries and the LEDs are installed inside the housing, the top of the housing is provided with a top ornament and a lower side of the housing is supported by the bottom seat.

2. The solar lamp according to claim 1, wherein the solar cell is fixed at the top of the housing with marine glue, the control circuit board, the rechargeable batteries and the LEDs are fixed on a cover board of battery box which is connected to an interior of the housing through screws.

3. The solar lamp according to claim 1, wherein the top ornament constructs a complete shape with the housing and the bottom seat, is assembled by parts of simple geometric shapes and is provided with a structure allowing a lot of light to leak out.

4. The solar lamp according to claim 2, wherein the top ornament constructs a complete shape with the housing and the bottom seat, is assembled by parts of simple geometric shapes and is provided with a structure allowing a lot of light to leak out.
